(19) United States
(12) Patent Application Publication
(10) Pub. No.: US 2003/0185248 A1
(43) Pub. Date: Oct. 2, 2003

(54) Simplified bandwidth handling for SDH/SONET access rings

(75) Inventors: Joshua Klipper, Natanya (IL); Udi Agami, Risbon-Le'Zion (IL); Alexei Merkushin, Kfar-Saba (IL); Uri Balas, Pardesiya (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/107,936

(22) Filed: Mar. 27, 2002

(51) Int. Cl. H04J 3/00

(52) U.S. Cl. 370/535; 370/907

(57) ABSTRACT

An apparatus and method for handling traffic on an SDH/SONET access network in which there are one or more central units and associated remote units, the remote units slaved to the frames generated by the central unit.

### TECHNICAL FIELD

The present invention is related in general to SDH/SONET networks and systems and more particularly to a method and apparatus for simplified bandwidth handling for SDH/SONET access rings.

### BACKGROUND INFORMATION

Telecommunication networks can be set up in many different physical topologies and using many different protocols. At a physical level, SDH/SONET ((Synchronous Optical NETwork) or SDH (Synchronous Digital Hierarchy) as it is known in Europe) is a very common standard worldwide, defining rates, frames, multiplexing schemes, payloads and all other aspects required to support universal transmission interfaces. Due to the high bandwidth it supports, SDH/SONET is often installed in ring topologies allowing multiple units to share the high bandwidth as well as to benefit from the protection inherent in the diverse routings available in rings. While SONET and SDH are different standards, the differences are not relevant to the present invention. Thus, in this application, “SDH/SONET” refers to both SDH and SONET networks.

SDH/SONET is based on a structured frame that is used to transport data and control information over a network. The frame is called a synchronous transfer signal (STS) in a SONET network and a synchronous transport module (STM) in an SDH network which will hereinafter be referred to as STM, for simplicity. The frame is a defined structure into which data and control information are inserted so that the far end can properly recover the information. In SDH/SONET frames, the start of user data is identified by pointers located in fixed locations within the frame. Pointer values can be changed based on synchronization or framing differences between received and transmitted data.

SDH/SONET transmission interfaces are available in many different types of equipment, of which the most common used in ring topologies are SDH/SONET multiplexers. In some cases, these multiplexers provide transmission or transport capability only, and other equipment is added to provide service interfaces. In other cases, SDH/SONET multiplex capability is integrated together with service platforms. While the latter approach provides a more compact and lower cost “single platform solution,” the former is generally more flexible and offers various interfaces which can be used to provide transport for different types of service platforms and in different parts of the telecommunications network.

### BRIEF DESCRIPTION OF THE DRAWINGS

FIG. 1 is an illustration of one example of an SDH/SONET ring including multiple remote units and a single central unit or node.

FIG. 2 is an illustration of a generic SDH/SONET ring including multiple nodes without a central node.

FIG. 3 is an illustration of a realignment function of a SDH/SONET node in a generic ring.

FIG. 4 is a diagram of a realignment function in a SDH/SONET remote unit in an access ring according to the teachings of the present invention.

FIG. 5 is a diagram of a realignment function in a SDH/SONET central unit in an access ring according to the teachings of the present invention.

FIG. 6 is a diagram of a multi-system access ring according to the teachings of the present invention.

### DETAILED DESCRIPTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural and/or design changes may be made without departing from the scope of the present invention.

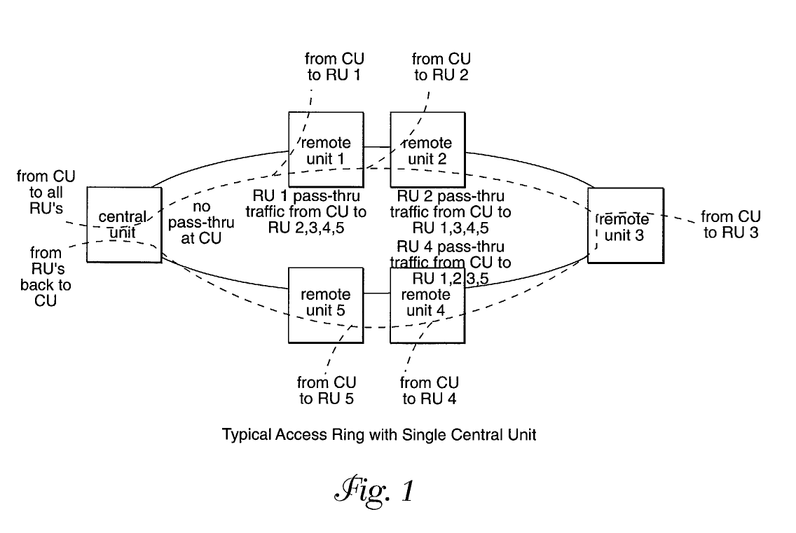

In an access network, i.e., a network or portion of a network that exists between the subscriber and the local switching office, both integrated and stand alone multiplexer approaches are available. Integrated solutions in which multiplex capability is integrated together with service platforms are often preferred due to the sensitivity to cost and physical size typical of access equipment installations. Access networks may be characterized by a single central unit (CU) to which is destined all traffic from multiple, “slave” remote units (RU) as shown in FIG. 1. FIG. 1 shows an access ring with five remote units and a single central unit. As shown in FIG. 1, each remote unit on the ring adds or drops its own traffic and also handles pass through traffic destined for other remote units. The central unit originates traffic for all of the remote units and handles no pass through traffic. The remote units communicate only to the central unit and not among themselves.

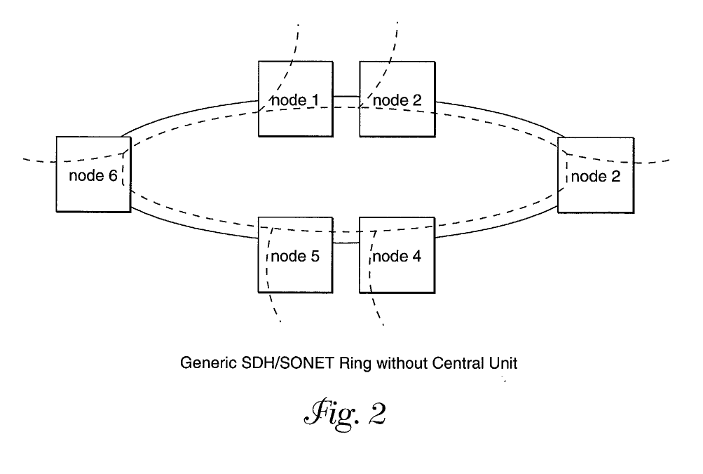

Various other applications throughout the telecommunications network lend themselves to a generic ring topology in which all nodes are essentially equal. An example of a generic SDH/SONET ring is shown in FIG. 2. As can be seen in FIG. 2, there is no “central” unit or node in the generic ring as there is in the access network of FIG. 1. Thus, any node on the ring must be able to add or drop traffic destined for that node, as well as “transparently” pass-thru traffic destined for a different node. In other words, in contrast to the access ring of FIG. 1, each of the nodes on the generic ring of FIG. 2 are essentially equal and can talk among themselves. To support this capability, equipment located in at least one node, and typically in all nodes, must be able to “realign” all pass-thru traffic so it can be combined with traffic to be added.

The realignment function of a node in a generic ring typically involves the recalculation of SDH/SONET pointers and/or at least partial processing and realignment of the traffic to be passed-thru the node. Such a capability typically requires extra hardware at each node to handle the traffic to be passed-thru. This is true whether traffic is passed-thru at the Virtual Container/Tributary level within a basic SDH/SONET synchronous transfer mode Nth level (STM-N) frame, or whether the traffic passed-thru is at a higher, STM-N level. This additional functionality results in added complexity and higher cost. The present invention offers a solution to the foregoing problems for SDH/SONET access rings and similar ring topologies that may be configured to include a central node and one or more remote nodes slaved to the central node.

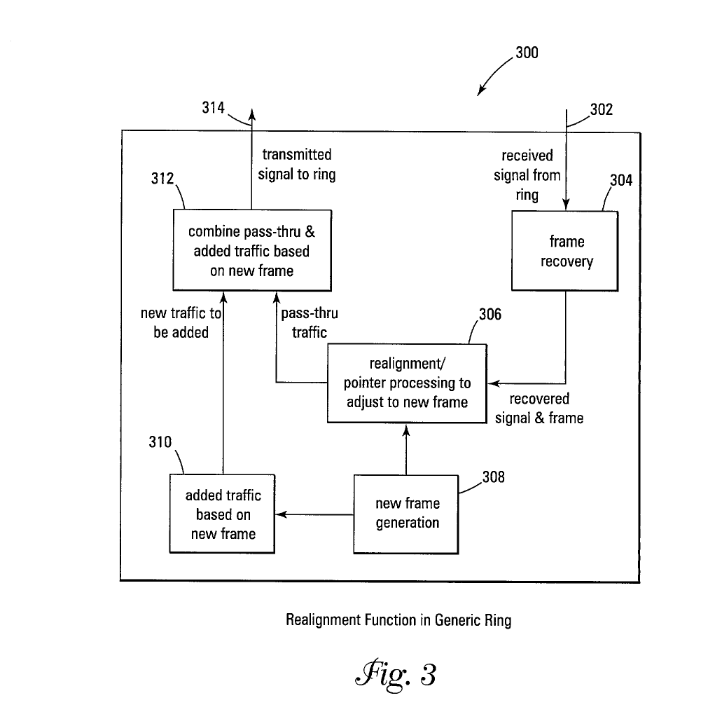

FIG. 3 shows a block diagram of a realignment function 300 performed at a node in a generic ring. In realignment function 300, the SDH/SONET signal is received from the ring at an input port 302. A frame recovery function 304 determines where the SDH/SONET frame begins from the input signal and passes the recovered signal and SDH/SONET frame to a realignment/pointer processing function 306. Realignment/pointer processing function 306 processes and realigns frame pointers that point to all the payloads within the SDH/SONET frame. Because this is a generic node where traffic may be added or dropped or passed through, there is also a new frame function 308 that generates a new frame. The generic node then takes the incoming traffic after realigning and adjusting the pointers of all of the payloads of the pass through traffic to this new frame, adds any new traffic to the new frame at 310, combines the pass through and added traffic to the new frame at 312. The new frame is then transmitted back out to the ring at an output port 314. In other words, because there is no master or central unit on the generic ring, the frame must be terminated or realigned at each generic node. Each generic node (and each generic multiplexer of the node) must have the capability of starting the frame anew and realigning all of the incoming signals to the new frame it generates because all of the nodes are equal.

In access network applications, where there is a central location to which traffic from all remote units is destined, the “realignment” function required in the generic application can be much simpler. The STM-N frame of the present invention essentially “starts” at the central unit and a simple free running counter serves to create the frame to be transmitted at the central unit. There is no traffic between the remote units and all traffic originates at the central unit. Processing at the remote units is thus greatly simplified. At each remote unit, the frame is recovered from the received signal, and it is used as the transmit frame to which the local traffic is added. Thus, a new frame is not generated at the remote unit. Processing of the same frame continues along the ring from remote unit to remote unit until returning to the central unit, where the received frame is terminated, and again a new transmit frame is created based on the simple counter. Since the frame is terminated, there is no pass-thru traffic at the central node, thus there is no need for a realignment function as shown in FIG. 3. This is in contrast to the generic implementation in which the uniform traffic distribution means there is no node without pass-thru traffic so that no arbitrary frame can be started based on a free running counter, and in at least one node, the frame must be created and all pass-thru traffic must be realigned to the new frame by recalculating the SDH/SONET pointers used to identify the start of the pass-thru payload within the SDH/SONET frame.

The SDH/SONET ring and bandwidth distribution scheme of the present invention is specifically suited for any access or local network in which there is a central node to act as a master.

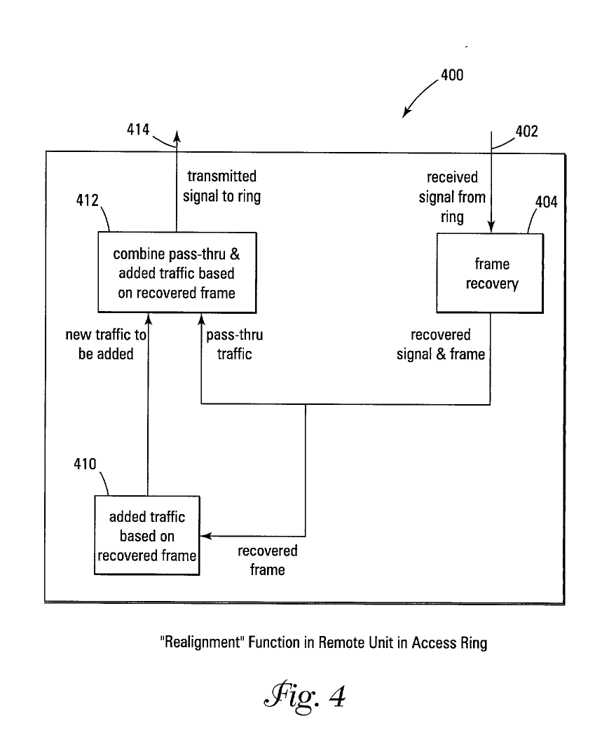

FIG. 4 shows the “realignment” function 400 at a remote node of a ring according to the present invention. At a remote node, the frame is received at an input port 402 and recovered at frame recovery function 404. The recovered frame is used as the basis for the transmit frame, with traffic to be added to the recovered frame at 410. The new traffic to be added is combined with pass through traffic at 412 and the frame is then transmitted back out to the ring at an output port 414. Thus, remote units are very simple and relatively inexpensive since the frame is recovered from the received signal and is simply “looped back,” with local traffic inserted into the available payload locations within the frame. Since a new frame is not created at the remote node realignment does not take place.

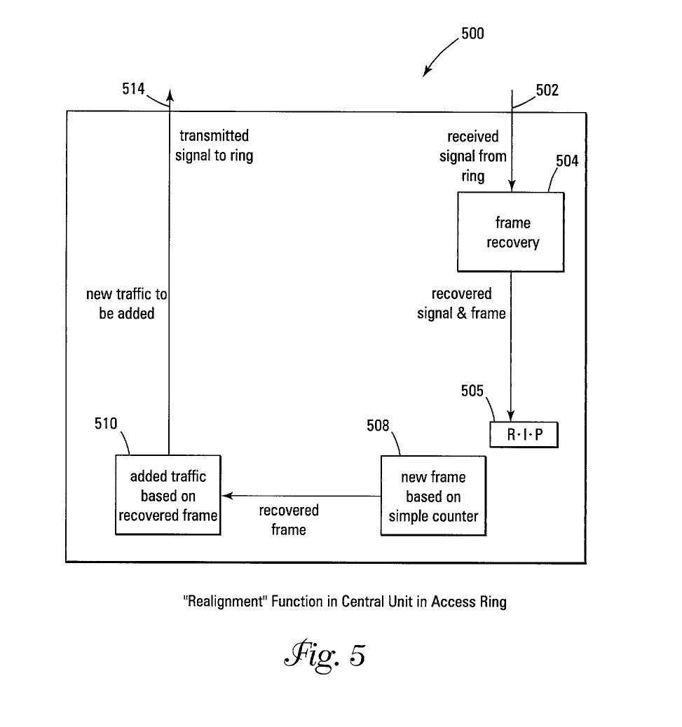

The central node of the present invention arbitrarily creates an STM-N frame with a simple counter/state machine at 508 as shown in FIG. 5, with no need to process pass-thru traffic or recalculate pointers since all traffic is terminated at the central node after it is recovered at 504. In “realignment” function 500, the SDH/SONET signal is received from the ring at an input port 502. A frame recovery function 504 determines where the SDH/SONET frame begins from the input signal and then terminates the frame at 505. A new frame is then created at 508 and new traffic is added to the new frame at 510. The new frame is then transmitted back out to the ring at an output port 514. Thus, in the present invention, the central unit is relatively simple since the frame is created with a simple counter or state machine instead of a pointer or payload processor which must handle all pass-thru traffic.

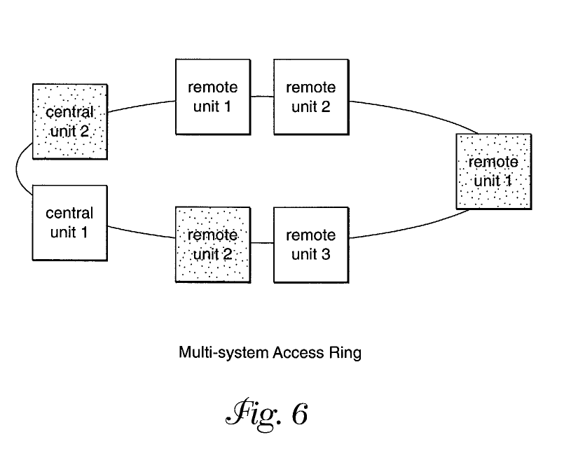

In addition to allowing the design of lower cost equipment for access rings, the present invention can also be applied to access rings with multiple integrated SDH/SONET access platforms as shown in FIG. 6. For example, if there is an access ring with four central units, each with its own group of remote units, an STM-4 ring can be used to interconnect the nodes with each central unit and its associated remote units, using a single STM-1 and forming an independent, logical ring on the actual STM-4 ring. Thus, each central unit and its associated remote units can handle their own STM-1 frames as in a simple, STM-1 ring, while the remaining three STM-1's are looped back transparently. Such an application is useful for access applications in which the capacity required exceeds that of a single system, but where the traffic is still characterized by a single central location and multiple “slave” remote units.

### Conclusion

A method and apparatus for bandwidth handling in an SDH/SONET access ring has been disclosed. The method and apparatus implements central and remote units in SDH/SONET access ring applications, in which no pointer or payload processing is required for pass-thru traffic at any node thus simplifying development and lowering hardware cost.

The present invention also includes an SDH/SONET ring that has one or more central nodes that originates and terminates an SDH/SONET frame and one or more remote units slaved to the central node, that recover the frames from the central node, add any new traffic to the recovered frame and combine the new traffic with pass through traffic in the recovered frame and then transmit the recovered frame back to the ring.

In another aspect of the present invention, a simple state machine or counter in a central unit generates SDH/SONET frames and simply loops back the pass-thru traffic at remote units. Locally added traffic at the remote units is inserted into the recovered frames without any realignment or pointer processing.

The present invention can also be applied to a multi-system ring, in which up to N central units can be co-located on a single STM-N ring, and in which each system (central and remote units) utilize its own STM-1 frame within the STM-N as a separate logical ring over the single physical STM-N ring.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. An SDH or SONET ring comprising:
a central unit to originate and terminate an SDH/SONET frame; and
a remote unit to recover the frame, add any new traffic to the recovered frame, combine the new traffic with pass through traffic in the recovered frame and transmit the recovered frame to the ring.

2. An SDH/SONET central node on an SDH/SONET ring comprising
a free running counter to create SDH/SONET frames to be transmitted to the ring without realignment by any other nodes on the ring.

3. An SDH/SONET central node on an SDH/SONET ring comprising
a free running counter to create SDH/SONET frames to be transmitted to the ring and in which there is no pass through traffic and no frame realignment at the central node.

4. An SDH/SONET remote node on an SDH/SONET ring, comprising
a frame processing module to recover frames from a signal received from a node on the ring wherein the recovered frame is used as a transmit frame to which local traffic may be added at the remote node.

5. A method of handling traffic on an SDH/SONET ring comprising a central node and a remote node, the method comprising:
generating an SDH/SONET frame at the central node;
transmitting the frame to the remote node on the ring;
recovering the frame at the remote node;
using the frame as a transmit frame to which local traffic may be added at the remote node;
transmitting the frame to a next node on the ring; and
terminating the frame after it returns to the central node.

6. The method of claim 5 wherein the ring comprises an access network.

7. The method of claim 5 wherein the ring comprises a local area network.

8. The method of claim 5 further comprising a plurality of central nodes each having one or more remote nodes slaved thereto, comprising multiple integrated SDH/SONET access platforms.

9. The method of claim 8 wherein each access platform utilizes its own STM-1 frame within an STM-N ring.

10. A method of handling traffic on an SDH/SONET ring comprising a plurality of nodes, the method comprising:
generating an SDH/SONET frame at a master node;
transmitting the frame to a slave node;
recovering the frame at the slave node;
adding any new traffic to the recovered frame;
combining pass through traffic and the any new traffic; and
transmitting the recovered frame back to the ring.

11. The method of claim 10 further comprising terminating the frame when it is returned to the master node.

12. A method of handling traffic on an SDH/SONET ring comprising a plurality of nodes, the method comprising:
receiving an SDH/SONET frame at a node on the ring; and
processing the SDH/SONET frame without performing a realignment of pass through traffic.

13. The method of claim 12 wherein the node is a remote node.

14. The method of claim 12 wherein the node is a central node at which the frame is originated and the frame is terminated.

15. The method of claim 12 wherein the frame is generated by a free running counter at a central node.

16. An SDH/SONET access network ring, comprising:
a central unit at which SDH/SONET frames are generated;
a plurality of remote units slaved to the central unit to receive and retransmit the SDH/SONET frames.

17. The SDH/SONET access ring of claim 16 wherein there is no realignment of traffic at the central unit.

18. A method of handling traffic on an SDH/SONET ring comprising a plurality of nodes, the method comprising:
receiving an SDH/SONET frame at a node on the ring; and
processing the SDH/SONET frame without creating a new frame.

19. An SDH/SONET access network comprising one or more central units that generate frames, each central unit having one or more remote units associated thereto, wherein the one or more remote units are slaved to the frames generated by the central unit to which they are associated.

20. A method of handling traffic on an SDH/SONET ring comprising one or more central units to generate and terminate frames, and one or more remote units associated with each central unit, the method comprising slaving the remote units to the frames generated and terminated by the central unit to which they are associated.

21. An SDH/SONET central node on an SDH/SONET ring comprising a free running counter to create an SDH/SONET frame to be transmitted to the ring, looped back without realignment by other nodes and terminated after it is returned to the central node.
